(19) United States
(12) Patent Application Publication
(10) Pub. No.: US 2019/0241258 A1
(43) Pub. Date: Aug. 8, 2019

(54) ROTOR BLADE DEFLECTION SENSING SYSTEM

(71) Applicants: SIKORSKY AIRCRAFT CORPORATION, Stratford, CT (US); United Technologies Corporation, Farmington, CT (US)

(72) Inventors: Derek Geiger, Wilton, CT (US); Seung Bum Kim, Manchester, CT (US); Claude G. Matalanis, Longmeadow, MA (US); Brian E. Wake, Glastonbury, CT (US); Patrick Bowles, Glastonbury, CT (US)

(21) Appl. No.: 16/316,872

(22) PCT Filed: May 12, 2017
(86) PCT No.: PCT/US17/32347

§ 371 Date: Jan. 10, 2019

Related U.S. Application Data
(60) Provisional application No. 62/362,944, filed on Jul. 15, 2016.

(51) Int. Cl. B64C 27/00; G01B 11/16

(52) U.S. Cl. CPC B64C 27/008; G01B 11/16

(57) ABSTRACT

A rotor blade deflection sensing system including a rotor blade having a first surface, a second surface, a third surface and a fourth surface. At least two fiber optic sensor arrays are mounted to the rotor blade. At least one of the at least two fiber optic sensor arrays is mounted to one of the first surface, the second surface, the third surface and the fourth surface and another of the at least two fiber optic sensor arrays being mounted to another of the first surface, a second surface, a third surface and a fourth surface. A controller is operatively connected to the at least two fiber optic sensor arrays. The controller determines one or more of a flapwise and an edgewise displacement based on inputs from the at least two fiber optic sensor arrays.

### STATEMENT OF FEDERAL SUPPORT

This invention was made with Government support under W911W6-13-2-0013 awarded by the United States Army. The Government has certain rights in the invention.

### BACKGROUND

Exemplary embodiments pertain to the art of rotary wing aircraft and, more particularly, to a system for sensing rotor blade motion in a rotary wing aircraft.

Rotary wing aircraft include rotor blades having control surfaces that are selectively manipulated to affect flight characteristics. The control surfaces may be manipulated by a pilot in the aircraft, a pilot remote from the aircraft, based on computer inputs from a flight control computer and/or combinations thereof. It may be desirable to provide feedback to the flight control computer regarding characteristics of the rotor blades to enhance control inputs. Current feedback systems employ accelerometers and/or proximity sensors either individually or in combination to monitor blade position and/or blade proximity.

### BRIEF DESCRIPTION

Disclosed is a rotor blade deflection sensing system including a rotor blade having a first surface, a second surface, a third surface and a fourth surface. At least two fiber optic sensor arrays are mounted to the rotor blade. At least one of the at least two fiber optic sensor arrays is mounted to one of the first surface, a second surface, a third surface and a fourth surface and another of the at least two fiber optic sensor arrays is mounted to another of the first surface, the second surface, the third surface and the fourth surface. A controller is operatively connected to the at least two fiber optic sensor arrays. The controller determines one or more of a flapwise and an edgewise displacement based on inputs from the at least two fiber optic sensor arrays.cl

In addition to one or more of the features described above or below, or as an alternative, further embodiments could include wherein the first surface defines a leading edge of the rotor blade and the second surface defines a trailing edge of the rotor blade.

In addition to one or more of the features described above or below, or as an alternative, further embodiments could include wherein the third surface extends between the leading edge and the trailing edge defining an upper blade surface and the fourth surface extends between the leading edge and the trailing edge defining a lower blade surface.

In addition to one or more of the features described above or below, or as an alternative, further embodiments could include wherein the at least two fiber optic sensor arrays include a first fiber optic sensor array mounted to the leading edge and a second fiber optic sensor array mounted to the trailing edge.

In addition to one or more of the features described above or below, or as an alternative, further embodiments could include wherein the at least two fiber optic sensor arrays includes a third fiber optic sensor array mounted to the upper blade surface.

In addition to one or more of the features described above or below, or as an alternative, further embodiments could include wherein the at least two fiber optic sensor arrays includes a third fiber optic sensor array mounted to the lower blade surface.

In addition to one or more of the features described above or below, or as an alternative, further embodiments could include wherein the at least two fiber optic sensor arrays includes a third fiber optic sensor array mounted to the upper blade surface and a fourth fiber optic array mounted to the lower blade surface.

In addition to one or more of the features described above or below, or as an alternative, further embodiments could include wherein the at least two fiber optic sensor arrays include a first fiber optic sensor array mounted to the upper blade surface and a second fiber optic sensor array mounted to the lower blade surface.

In addition to one or more of the features described above or below, or as an alternative, further embodiments could include wherein the at least two fiber optic sensor arrays includes a third fiber optic sensor array mounted to one of the leading edge and the trailing edge.

In addition to one or more of the features described above or below, or as an alternative, further embodiments could include wherein each of the at least two fiber optic sensor arrays include a sensor array having n-sensors per p-modes being sensed.

Also disclosed is a rotary wing aircraft including an airframe having an extending tail, one or more engines supported by the airframe, and a rotor assembly operatively connected to the one or more engines. The rotor assembly including a hub and a plurality of rotor blades extending radially outwardly of the hub, each of the plurality of rotor blades including a first surface, a second surface, a third surface and a fourth surface. A rotor blade deflection sensing system includes at least two fiber optic sensor arrays mounted to at least one of the plurality of rotor blades. At least one of the at least two fiber optic sensor arrays is mounted to one of the first surface, the second surface, the third surface and the fourth surface and another of the at least two fiber optic sensor arrays is mounted to another of the first surface, a second surface, a third surface and a fourth surface. A controller is operatively connected to the at least two fiber optic sensor arrays. The controller determines one or more of a flapwise and an edgewise displacement based on inputs from the at least two fiber optic sensor arrays.

In addition to one or more of the features described above or below, or as an alternative, further embodiments could include wherein the first surface defines a leading edge of one of the plurality of rotor blades and the second surface defines a trailing edge of the one of the plurality of rotor blades, the third surface extends between the leading edge and the trailing edge defining an upper blade surface and the fourth surface extends between the leading edge and the trailing edge defining a lower blade surface.

In addition to one or more of the features described above or below, or as an alternative, further embodiments could include wherein the at least two fiber optic sensor arrays include a first fiber optic sensor array mounted to the leading edge and a second fiber optic sensor array mounted to the trailing edge.

In addition to one or more of the features described above or below, or as an alternative, further embodiments could include wherein the at least two fiber optic sensor arrays includes a third fiber optic sensor array mounted to one of the upper blade surface and the lower blade surface.

In addition to one or more of the features described above or below, or as an alternative, further embodiments could include wherein the at least two fiber optic sensor arrays include a first fiber optic sensor array mounted to the upper blade surface and a second fiber optic sensor array mounted to the lower blade surface.

### BRIEF DESCRIPTION OF THE DRAWINGS

The following descriptions should not be considered limiting in any way. With reference to the accompanying drawings, like elements are numbered alike:

FIG. 1 depicts a side view of a rotary wing aircraft, including a rotor blade deflection sensing system, in accordance with an exemplary embodiment;

FIG. 2 is partial perspective view of a rotor blade of the rotary wing aircraft of FIG. 1 depicting fiber optic sensor arrays for measuring rotor blade deflection, in accordance with an exemplary embodiment; and

FIG. 3 depicts a block diagram illustrating the rotor blade deflection sensing system, in accordance with an exemplary embodiment.

### DETAILED DESCRIPTION

A detailed description of one or more embodiments of the disclosed apparatus and method are presented herein by way of exemplification and not limitation with reference to the Figures.

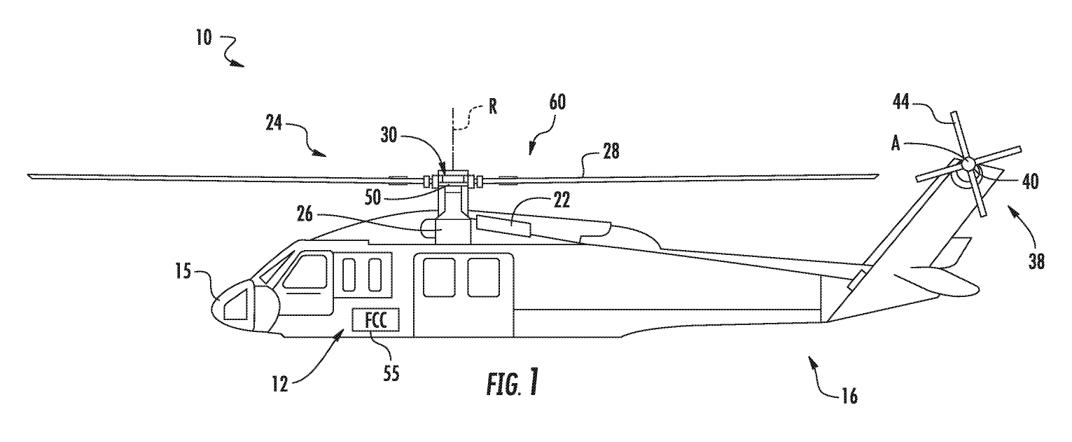

FIG. 1 schematically illustrates a rotary wing aircraft 10 having an airframe 12 having a nose 15 and an extending tail 16. One or more engines 22 are supported in airframe 12 and are operatively connected to a main rotor assembly 24 through a gearbox 26. Main rotor assembly 24 includes a plurality of rotor blades, one of which is indicated at 28 mounted to a hub 30 and driven about a main rotor axis “R” by one or more engines 22. Extending tail 16 supports a tail rotor system 38, such as an anti-torque system, a translational thrust system, a pusher propeller, a rotor propulsion system, and the like. Tail rotor system 38 includes a tail rotor hub 40 that supports a plurality of tail rotor blades 44 that rotate about a tail rotor axis “A”. Tail rotor axis “A” is substantially perpendicular to main rotor axis “R”.

A swashplate 50 provides control movements to rotor blades 28. More specifically, swashplate 50 is activated to affect a state or orientation of the rotor blades 28. Swashplate 50 actuation may be enhanced by inputs from a flight control computer 55. Although a particular helicopter configuration is illustrated and described in the disclosed embodiment, other configurations and/or machines, such as high speed compound rotary wing aircraft with supplemental translational thrust systems, dual contra-rotating, or co-rotating coaxial rotor system aircraft, turbo-props, tilt-rotors and tilt-wing aircraft may also benefit from the exemplary embodiments described herein.

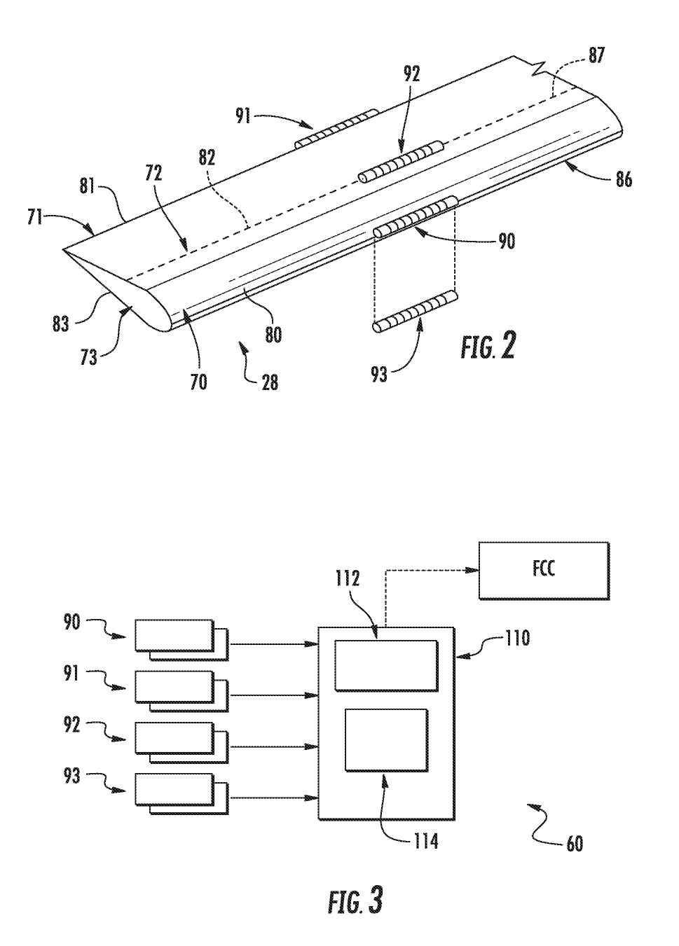

In accordance with an aspect of an exemplary embodiment, rotary wing aircraft 10 includes a rotor blade deflection sensing system 60 that detects rotor blade shape and provides feedback to flight control computer 55 that enhances blade control to improve flight characteristics. At this point, a description will follow to FIG. 2 in describing details rotor blades 28 with an understanding that others of the plurality of rotor blades may include similar structure. Rotor blade 28 includes a first surface 70, an opposing second surface 71, a third surface 72, and a fourth surface 73 opposite third surface 72. First surface 70 defines a leading edge 80, second surface 71 defines a trailing edge 81, third surface 72 defines an upper blade surface 82 and fourth surface 73 defines a lower blade surface 83. Leading edge 80 includes a centerline 86 and rotor blade 28 includes a longitudinal axis 87 that extends from a root end portion (not separately labeled) to a tip end portion (also not separately labeled) between leading edge 80 and trailing edge 81. Longitudinal axis 87 may be spaced a desired distance from leading edge 80. It is to be understood that the terms “upper” and “lower” are exemplary and should not be construed as limiting.

In further accordance with an exemplary embodiment, rotor blade deflection sensing system 60 includes a first fiber optic sensor array 90 mounted to leading edge 80 and may be arranged at centerline 86. A second fiber optic sensor array 91 may be arranged at trailing edge 81, a third fiber optic sensor array 92 may be arranged on upper blade surface 82 and a fourth fiber optic sensor array 93 may be arranged on lower blade surface 83. Fiber optic sensor arrays 90-93 may be arranged adjacent to the root portion of rotor blade 28. It is to be understood that each fiber optic sensor array includes (n) sensors arranged in (p) rows. In general, sensor numbers (n) correspond to a number of modes, e.g., flapwise and edgewise bending modes. A selected number of sensor array rows are employed to decompose dynamic responses into flapwise, and edgewise strains to be sensed in connection with rotor blade 28. The use of multiple sensor arrays compensates for centrifugal effects perceived by each rotor blade 28.

It is also to be understood that the number and location of fiber optic sensor arrays may vary. For example, in accordance with one aspect, fiber optic sensor arrays may be arranged on leading edge 80 and trailing edge 81. In accordance with another aspect, fiber optic sensor arrays may be arranged on upper blade surface 82, lower blade surface 83 and one or more of leading edge 80 and trailing edge 81. It is to be understood that the number, location and position of fiber optic sensor arrays may vary and may depend on desired modes to be sensed.

In still further accordance with an exemplary aspect, fiber optic sensor arrays 90-93 for each of the plurality of rotor blades 28 is operatively coupled to a controller 110 as shown in FIG. 3. Controller 110 may include a central processor unit (CPU) 112 and a blade deflection controller 114 that receives signals from fiber optic sensor arrays 90-93 and provides inputs to flight control computer 55. With this arrangement, strategically placed fiber optic sensor arrays are positioned to capture and provide signals to controller 110. In turn, controller 110 decomposes captured or measured signals into multiple states providing decomposed signals to flight control computer 55 which, in turn, may be used as inputs for rotor and/or air vehicle control.

In an example, three or more sensors strategically positioned at the same spanwise position of rotor blade 28 may collaborate to decompose centrifugal, flapwise, and edgewise strains. For instance, measured dynamic strain can be instantly separated into strains introduced by flapwise motion, edgewise motion, and centrifugal effect, respectively. Decomposition of measured strain signals can simplify the treatment of signals using filters which may be present in flight control computer 55. In addition, fiber optic sensor arrays possess a multiplexing capability that enables easier construction of the sensed signals.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A rotor blade deflection sensing system comprising:
a rotor blade including a first surface, a second surface, a third surface and a fourth surface;
at least two fiber optic sensor arrays mounted to the rotor blade, at least one of the at least two fiber optic sensor arrays being mounted to one of the first surface, the second surface, the third surface and the fourth surface and another of the at least two fiber optic sensor arrays being mounted to another of the first surface, a second surface, a third surface and a fourth surface; and
a controller operatively connected to the at least two fiber optic sensor arrays, the controller determining one or more of a flapwise and an edgewise displacement based on inputs from the at least two fiber optic sensor arrays.

2. The rotor blade deflection sensing system according to claim 1, wherein the first surface defines a leading edge of the rotor blade and the second surface defines a trailing edge of the rotor blade.

3. The rotor blade deflection sensing system according to claim 2, wherein the third surface extends between the leading edge and the trailing edge defining an upper blade surface and the fourth surface extends between the leading edge and the trailing edge defining a lower blade surface.

4. The rotor blade deflection sensing system according to claim 3, wherein the at least two fiber optic sensor arrays include a first fiber optic sensor array mounted to the leading edge and a second fiber optic sensor array mounted to the trailing edge.

5. The rotor blade deflection sensing system according to claim 4, wherein the at least two fiber optic sensor arrays includes a third fiber optic sensor array mounted to the upper blade surface.

6. The rotor blade deflection sensing system according to claim 4, wherein the at least two fiber optic sensor arrays includes a third fiber optic sensor array mounted to the lower blade surface.

7. The rotor blade deflection sensing system according to claim 4, wherein the at least two fiber optic sensor arrays includes a third fiber optic sensor array mounted to the upper blade surface and a fourth fiber optic array mounted to the lower blade surface.

8. The rotor blade deflection sensing system according to claim 3, wherein the at least two fiber optic sensor arrays include a first fiber optic sensor array mounted to the upper blade surface and a second fiber optic sensor array mounted to the lower blade surface.

9. The rotor blade deflection sensing system according to claim 8, wherein the at least two fiber optic sensor arrays includes a third fiber optic sensor array mounted to one of the leading edge and the trailing edge.

10. The rotor blade deflection sensing system according to claim 1, wherein each of the at least two fiber optic sensor arrays include a sensor array having n-sensors per m-modes being sensed.

11. A rotary wing aircraft comprising:
an airframe having an extending tail;
one or more engines supported by the airframe;
a rotor assembly operatively connected to the one or more engines, the rotor assembly including a hub and a plurality of rotor blades extending radially outwardly of the hub, each of the plurality of rotor blades including a first surface, a second surface, a third surface and a fourth surface;
a rotor blade deflection sensing system including at least two fiber optic sensor arrays mounted to at least one of the plurality of rotor blades, at least one of the at least two fiber optic sensor arrays being mounted to one of the first surface, the second surface, the third surface and the fourth surface and another of the at least two fiber optic sensor arrays being mounted to another of the first surface, a second surface, a third surface and a fourth surface; and
a controller operatively connected to the at least two fiber optic sensor arrays, the controller determining one or more of a flapwise and an edgewise displacement based on inputs from the at least two fiber optic sensor arrays.

12. The rotary wing aircraft according to claim 11, wherein the first surface defines a leading edge of one of the plurality of rotor blades and the second surface defines a trailing edge of the one of the plurality of rotor blades, the third surface extends between the leading edge and the trailing edge defining an upper blade surface and the fourth surface extends between the leading edge and the trailing edge defining a lower blade surface.

13. The rotary wing aircraft according to claim 12, wherein the at least two fiber optic sensor arrays include a first fiber optic sensor array mounted to the leading edge and a second fiber optic sensor array mounted to the trailing edge.

14. The rotary wing aircraft according to claim 13, wherein the at least two fiber optic sensor arrays includes a third fiber optic sensor array mounted to one of the upper blade surface and the lower blade surface.

15. The rotary wing aircraft according to claim 12, wherein the at least two fiber optic sensor arrays include a first fiber optic sensor array mounted to the upper blade surface and a second fiber optic sensor array mounted to the lower blade surface.
